(19) United States
(12) Patent Application Publication
(10) Pub. No.: US 2014/0136947 A1
(43) Pub. Date: May 15, 2014

(54) GENERATING WEBSITE ANALYTICS

(71) Applicant: INTERNATIONAL BUSINESS MACHINES CORPORATION, Armonk, NY (US)

(72) Inventors: Indran Naick, Cedar Park, TX (US); Kevin G. Paterson, San Antonio, TX (US); Theodore J.L. Shrader, Austin, TX (US); Clifford J. Spinac, Austin, TX (US)

(73) Assignee: INTERNATIONAL BUSINESS MACHINES CORPORATION, Armonk, NY (US)

(21) Appl. No.: 13/677,595

(22) Filed: Nov. 15, 2012

(51) Int. Cl. G06F 17/00

(52) U.S. Cl. 715/234

(57) ABSTRACT

Embodiments of the invention disclose a method for using website analytics to control factors associated with the display and use of website content. The method may include receiving first information relating to use of content elements within a first webpage. The method may also include determining a ranking of the content elements according to the first information. The method may also include generating elevation graphics data for an elevation map of the first webpage, wherein the elevation graphics data corresponds to the ranking of the content elements. The method may also include controlling user interface factors of the first webpage with respect to the elevation graphics data of the elevation map.

### TECHNICAL FIELD

The present invention relates to the field of website analytics, and more specifically, controlling factors associated with the display and use of website content.

### BACKGROUND

In the decades since its inception, the internet and the content contained therein has grown exponentially. In conjunction with that growth is the increase in the ways in which that content is presented to users of the internet, and in the ways in which to navigate that content.

### SUMMARY

Embodiments of the invention disclose a method for using website analytics to control factors associated with the display and use of website content. The method may include receiving first information relating to use of content elements within a first webpage. The method may also include determining a ranking of the content elements according to the first information. The method may also include generating elevation graphics data for an elevation map of the first webpage, wherein the elevation graphics data corresponds to the ranking of the content elements. The method may also include controlling user interface factors of the first webpage with respect to the elevation graphics data of the elevation map.

Other embodiments of the invention disclose a method that may include receiving first information relating to use of content elements within a first webpage. The method may also include determining a ranking of the content elements according to the first information. The method may also include generating elevation graphics data for an elevation map of the first webpage, wherein the elevation graphics data corresponds to the ranking of the content elements. The method may also include replacing a first content element of the first webpage with a scaled representation of a second content element of a second webpage.

### BRIEF DESCRIPTION OF THE SEVERAL VIEWS OF THE DRAWINGS

FIG. 1 depicts a high-level block diagram of an exemplary system for implementing an embodiment of the invention.

FIG. 2A depicts a block diagram of an example data structure for a page table, according to an embodiment of the invention.

FIG. 2B depicts a block diagram of an example data structure for an elevation table, according to an embodiment of the invention.

FIG. 3 depicts a block diagram of an example process for receiving information, ranking webpage content, generating elevation graphics data for an elevation map, controlling user interface factors of a display, and moving content, according to an embodiment of the invention.

FIG. 4 depicts a flowchart of an example process for receiving information relating to use of webpage content, according to an embodiment of the invention.

FIG. 5 depicts a flowchart of an example process for assigning webpage content a rank, according to an embodiment of the invention.

FIG. 6A depicts a flowchart of an example process for using an elevation map to controlling user interface factors of a pointing device or a display area through a form of pseudo gravity, according to an embodiment of the invention.

FIG. 6B depicts a flowchart of an example process for using an elevation map to controlling user interface factors of a pointing device or a display area through a form of pseudo friction, according to an embodiment of the invention.

FIG. 7A depicts a flowchart of an example processing for replacing content elements with scaled representation of other content elements, according to an embodiment of the invention.

FIG. 7B depicts a first webpage and a second webpage prior to moving content, according to an embodiment of the invention.

FIG. 7C depicts a first webpage and a second webpage after moving content, according to an embodiment of the invention.

In the drawings and the Detailed Description, like numbers generally refer to like components, parts, steps, and processes.

### DETAILED DESCRIPTION

Users of internet websites are continuously presented with large amounts of information in a variety of display formats. The measurement, collection, analysis, and reporting of website use may be referred to as website analytics. The purpose of website analytics may include understanding and optimizing website design and use. Website users may utilize this information to improve their experience by making more used content more readily accessible. A user's website experience may also be improved by providing a way for the content of a website to automatically interact with the user. The understanding of web analytics may also be utilized by website designers to improve a user's experience by providing the designer with information related to how users view and interact with the content of the website.

Embodiments of the present invention provide an improved manner of utilizing website analytics. This may include collecting usage data from multiple website users and utilizing that data to determine which content is favored. This may be accomplished by monitoring how the users interact with the website's content and, using that information, ranking that content relative to its level of use. Once all the elements of a webpage have been ranked relative to each other, the rankings may be applied to the webpage. This application may produce an elevation map of the webpage content elements with content rankings providing the map's elevations. Once generated this elevation map may be utilized to more prominently display favored, or higher ranked, content by automatically moving it into display areas that are more visible and accessible to users. This may include moving content from one location of a webpage to another, for example from the edge to the middle, or it may include moving content from one webpage to another, for example from one page of a website to its home page. The elevation map may also be utilized to control user interface factors of a user's pointing device or a user's webpage display to direct the user to the favored content. For example, a user's mouse or touch screen may automatically be moved toward favored content of a website without assistance from the user, resulting in a form of pseudo gravity acting on the mouse or touch screen. Another example is speeding up the movement of the mouse or touch screen when it is moved towards more favored content and slowing it down when it is move towards less favored content, resulting in a form of pseudo friction.

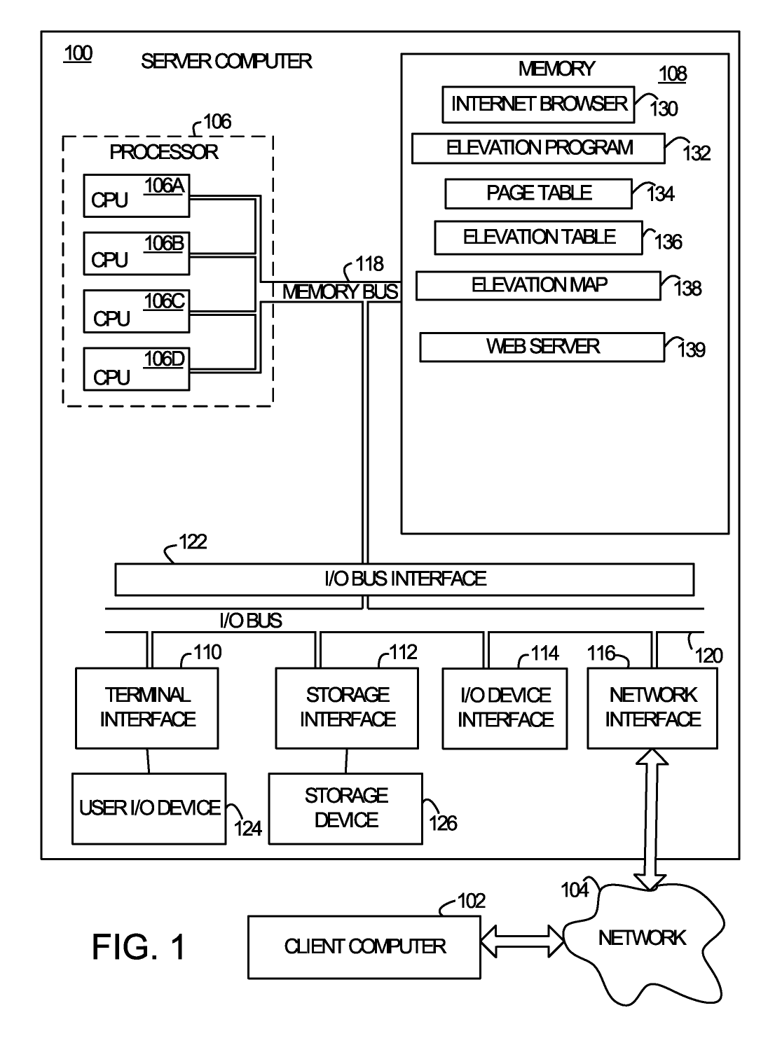

Referring to the drawings, wherein like numbers denote like parts throughout the several views, FIG. 1 depicts a high-level block diagram representation of a server computer system 100 connected to a client computer system 102 via a network 104, according to an embodiment of the present invention. The terms “server” and “client” are used herein for convenience only, and in various embodiments a computer system that operates as a client computer in one environment may operate as a server computer in another environment, and vice versa. The mechanisms and apparatus of embodiments of the present invention apply equally to any appropriate computing system, including a computer system that does not employ the client-server model.

The major components of the computer systems 100 and 102 (only one shown in detail for clarity) may include one or more processors 106, a main memory 108, a terminal interface 110, a storage interface 112, an I/O (Input/Output) device interface 114, and a network interface 116, all of which may be communicatively coupled, directly or indirectly, for inter-component communication via a memory bus 118, an I/O bus 120, and an I/O bus interface unit 122.

The computer system 100 may contain one or more general-purpose programmable central processing units (CPUs) 106A, 106B, 106C, and 106D, herein generically referred to as the processor 106. In an embodiment, the computer system 100 may contain multiple processors typical of a relatively large system; however, in another embodiment the computer system 100 may alternatively be a single CPU system. Each processor 106 may execute instructions stored in the main memory 108 and may include one or more levels of on-board cache.

In an embodiment, the main memory 108 may include a random-access semiconductor memory, storage device, or storage medium (either volatile or non-volatile) for storing or encoding data and programs. In another embodiment, the main memory 108 may represent the entire virtual memory of the computer system 100, and may also include the virtual memory of other computer systems coupled to the computer system 100 or connected via the network 104. The main memory 108 may be conceptually a single monolithic entity, but in other embodiments the main memory 108 may be a more complex arrangement, such as a hierarchy of caches and other memory devices.

The main memory 108 may store or encode an internet browser 130, an elevation program 132, a page table 134, an elevation table 136, an elevation map 138, and a web server 139. Although the internet browser 130, the elevation program 132, the page table 134, the elevation table 136, the elevation map 138, and the web server 139 are illustrated as being contained within the memory 108 in the computer system 100, in other embodiments some or all of them may be on different computer systems and may be accessed remotely, e.g., via the network 104. The computer system 100, 102 may use virtual addressing mechanisms that allow the programs of the computer system 100, 102 to behave as if they only have access to a large, single storage entity instead of access to multiple, smaller storage entities. Thus, while the internet browser 130, the elevation program 132, the page table 134, the elevation table 136, the elevation map 138, and the web server 139 are illustrated as being contained within the main memory 108, these elements are not necessarily completely contained in the same storage device at the same time. Further, although the internet browser 130, the elevation program 132, the page table 134, the elevation table 136, the elevation map 138, and the web server 139 are illustrated as being separate entities, in other embodiments some of them, portions of some of them, or all of them may be packaged together.

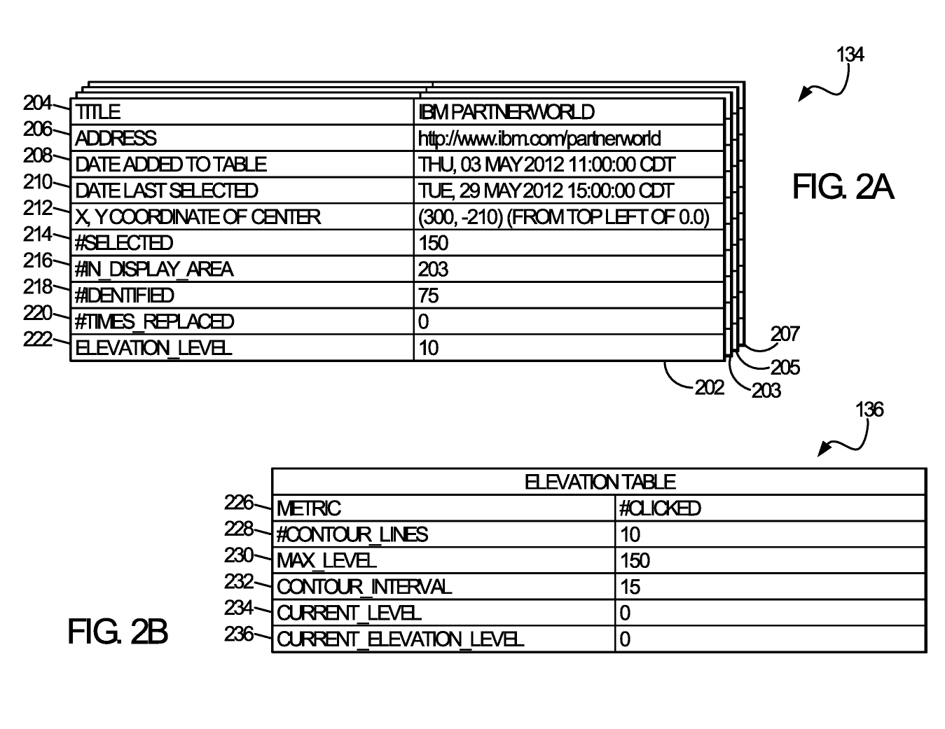

In an embodiment, the internet browser 130, the elevation program 132, the page table 134, the elevation table 136, the elevation map 138, and the web server 139 may include instructions or statements that execute on the processor 106 or instructions or statements that may be interpreted by instructions or statements that execute on the processor 106, to carry out the functions as further described below with reference to FIGS. 2, 3, 4, 5, 6, and 7. In another embodiment, the internet browser 130, the elevation program 132, the page table 134, the elevation table 136, the elevation map 138, and the web server 139, or two or more of these elements may be implemented in hardware via semiconductor devices, chips, logical gates, circuits, circuit cards, other physical hardware devices, or a combination of these devices in lieu of, or in addition to, a processor-based system. In an embodiment, the internet browser 130, the elevation program 132, the page table 134, the elevation table 136, the elevation map 138, and the web server 139, or two or more of these elements may include data in addition to instructions or statements.

The memory bus 118 may provide a data communication path for transferring data among the processor 106, the main memory 108, and the I/O bus interface 122. The I/O bus interface 122 may be further coupled to the I/O bus 120 for transferring data to and from the various I/O units. The I/O bus interface unit 122 communicates with multiple I/O interface units 110, 112, 114, and 116, which may also be known as I/O processors (IOPs) or I/O adapters (IOAs), through the I/O bus 120.

The I/O interface units support communication with a variety of storage and I/O devices. For example, the terminal interface unit 110 supports the attachment of one or more user I/O devices 124, which may include user output devices (such as a video display device, speaker, or television set) and user input devices (such as a keyboard, mouse, keypad, touchpad, trackball, buttons, light pen, or other pointing device). A user may manipulate the user input devices utilizing a user interface, in order to provide input data and commands to the user I/O device 124 and the computer system 100, and may receive output data via the user output devices. For example, a user interface may be presented via the user I/O device 124, such as displayed on a display device, played via a speaker, or printed via a printer.

The storage interface 112 supports the attachment of one or more disk drives or direct access storage devices 126 (which are typically rotating magnetic disk drive storage devices, although they could alternatively be other storage devices, including arrays of disk drives configured to appear as a single large storage device to a host computer). In another embodiment, the storage device 126 may be implemented via any type of secondary storage device. The contents of the main memory 108, or any portion thereof, may be stored to and retrieved from the storage device 126 as needed. The I/O device interface 114 may provide an interface to any of various other input/output devices or devices of other types, such as printers or fax machines. The network interface 116 may provide one or more communications paths from the computer system 100 to other digital devices and computer systems 102; such paths may include, e.g., one or more networks 104.

FIG. 2A depicts a block diagram of an example data structure for a page table 134, according to an embodiment of the invention. The page table 134 may include any number of records and may include a record for each content element within a webpage. A content element may be any information that is displayed on a webpage. For example, a content element may be text, pictures, or any other similar element. Content elements may contain links which, when selected, may change the webpage display by changing the content elements within the webpage, or by taking the user to another webpage.

In one example, the page table 134 may include example records 202, 203, 205, and 207. Each record may include any information related to the content element. This information may include a title of the content element 204, a web address 206, a date the content element was added to the page table 208, a date the content element was last selected 210, and x,y coordinates of the center of the content element 212. The information may also include cumulative totals of occurrences of user interaction with the content element. These types of interactions may be considered a set of metrics for the content element and they may represent use of a single user or use of multiple users. For example, a page table 134 may be present within the memory of a user's computer 102 and may only contain information related to that user's use of a webpage. However, a page table 134 may also be present on a server computer 100 and contain usage information related to multiple users and communicated to the server computer 100 from the user's computers 102 via a network 102.

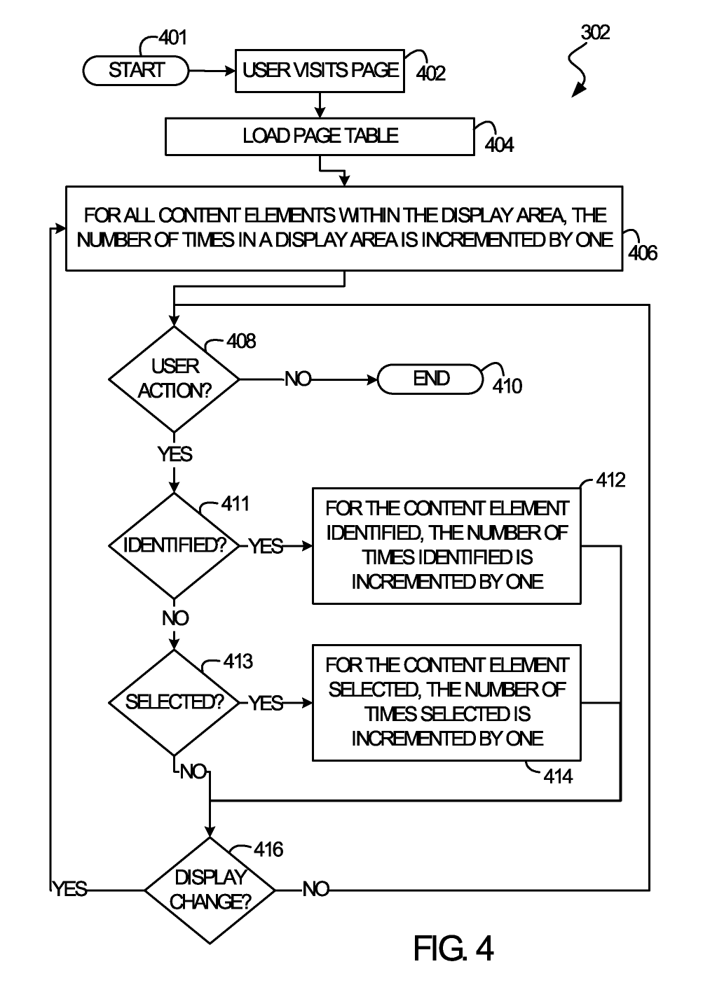

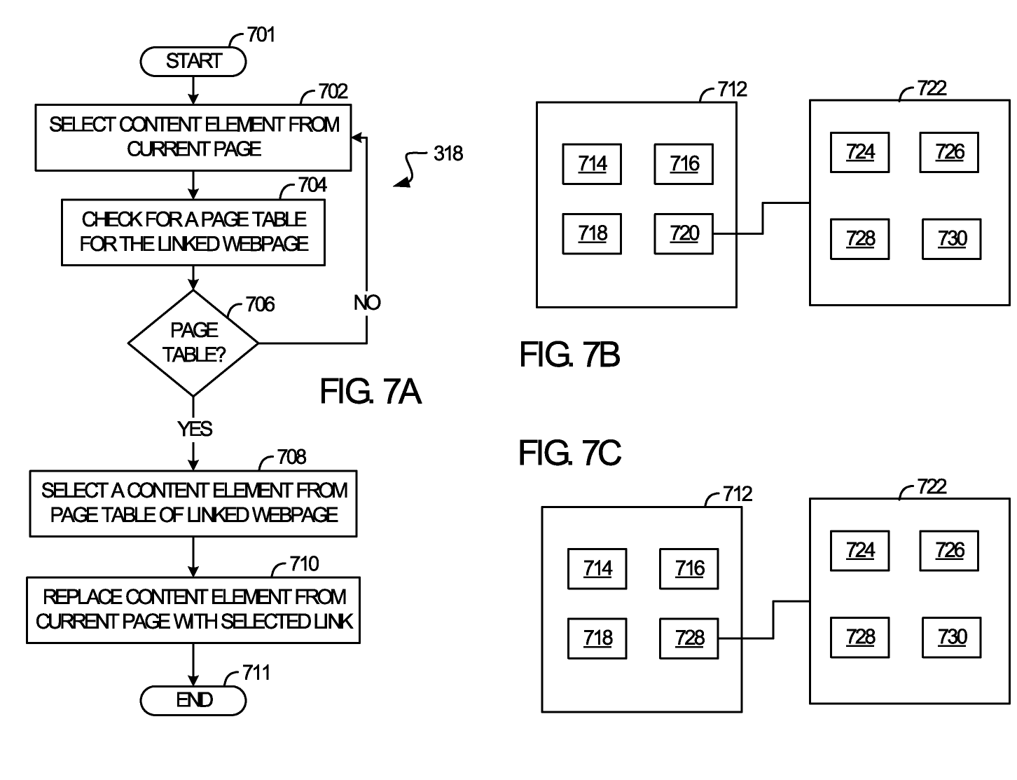

Examples of metrics are a number of times a content element has been selected 214, a number of times a content element is in a display area 216, a number of times a content element has been identified 218, and a number of times a scaled representation of a content element has replaced another content element 220. An example of the cumulative nature of the values associated with the metrics may be incrementing the value for the number of times a content element has been selected 214 whenever a user selects the respective content element. This process is explained in further detail below with reference to FIG. 4. The number of times a content element has been selected 214 includes the number of times a user or users have selected the respective content element. For example, a user may select a content element by clicking on it with a mouse pointer or tapping it with a touch screen device. The number of times a content element is in a display area 216 includes the number of times the respective content element was present within a display area after a webpage was loaded or refreshed. The number of times a content element has been identified 218 includes the number of times a user has identified a focal point of an image element in a way that may be considered user interest in that content element, and may take the form a hover, zoom, or pointing action. For example, when a user moves a pointing device to a content element, the user may be examining the content but has not yet selected the content element. The number of times a scaled representation of a content element has replaced another content element 220 includes the number of times a scaled representation of a content element has been moved from a secondary webpage to a primary webpage so that the content element may be more readily available to the user. The process of moving content is further explained below with reference to FIG. 7. The information within the page table 134 may also include information related to the elevation map 138 such as an elevation level 222. The elevation level 222 of a content element may be an elevation value assigned to the respective content element and may be used to determine the content element's relative elevation within the elevation map 138.

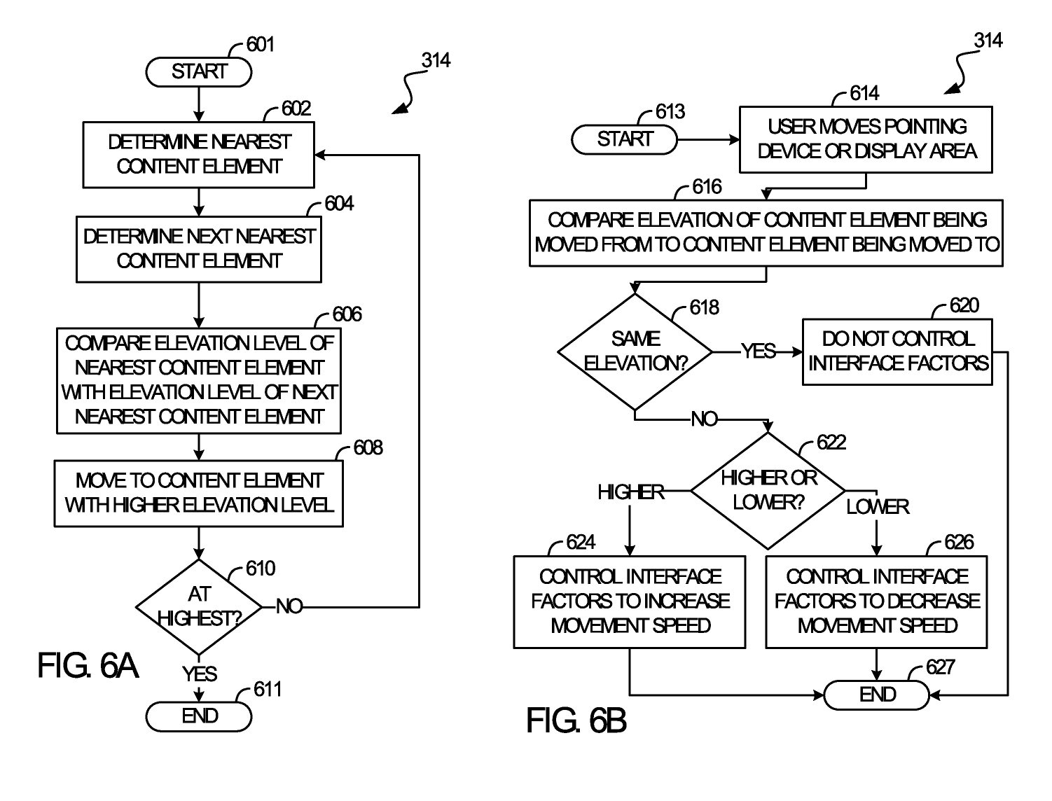

FIG. 2B depicts a block diagram of an example data structure for an elevation table 136, according to an embodiment of the invention. The elevation table 136 may include any information related to generating the elevation map 138 for a webpage. The elevation map 138 may be used by the elevation program 132 in conjunction with the webpage in order to control user interface factors of a pointing device or a display area. The elevation map 138 may also be overlaid on a webpage to give a user a visual layout of the webpage content's level of use. The elevation map 138 may also be used to control user interface factors of the user's pointing device or actions on the page. This control may take the form of a pseudo gravity corresponding to the elevation level 222 differences of the map. For example, if a pointing device is nearest a content element with a lower elevation level 222 than any surrounding content element, then the elevation program 132 may move the pointing device toward another content element with a higher elevation level 222. For example, if a pointing device is nearest a content element with an elevation level 222 of 100 but there is a surrounding content element with a value of 150, the elevation program 132 may move the pointing device to the content element with the elevation level 222 of 150. This process is explained in further detail below with reference to FIGS. 6A and 6B.

Embodiments of the invention may also exert control through pseudo friction as users navigate across the page with their pointing device. For example, as users move a pointing device to a content element with an elevation level 222 equal to the elevation level 222 of the content element from which it moved, the pointing device may move normally. However, as the pointing device moves to a content element with a higher elevation level 222 than the content element from which it moved, the pointer may move more rapidly. Conversely, as the pointing device moves to a content element with a lower elevation level 222 than the content element from which it moved, the pointer may move more slowly. This may result in helping to guide users, through the movement of their pointing device, to more favored content of a webpage. The elevation map 138 may also be used on multiple devices. For example, a user may use the same elevation map 138 on a computer, an electronic tablet, or a mobile phone.

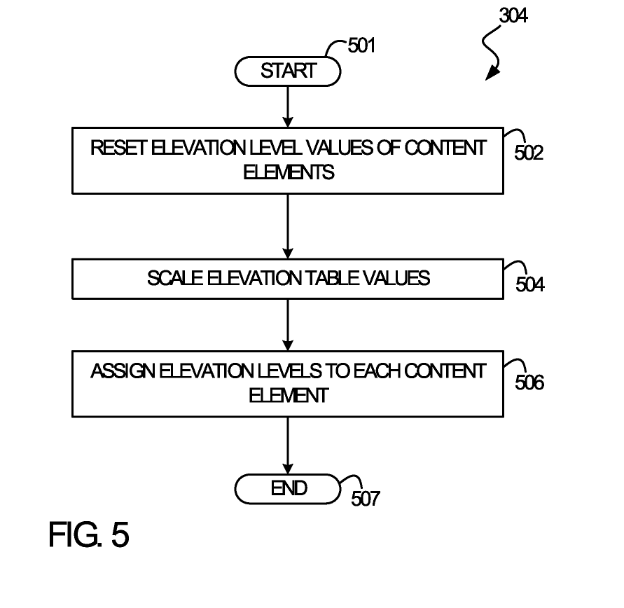

The elevation table 136 may include a metric 226 to be used to generate an elevation map 138. The metric 226 may be used to determine the values of other information within the elevation table 136. This determination is explained in further detail below with reference to FIG. 5. The metric 226 may be selected from one of the metrics of the page table 134. For example, the metric 226 may be the number of times a content element has been selected 214.

The elevation table 136 may also include a number of contour lines 228 to be used in the elevation map 138, a maximum elevation level 230 of the elevation map 138, a contour interval 232, a current level 234 and a current elevation level 236. The number of contour lines 228 to be used in the elevation map 138 may be used to determine the values of other information within the elevation table 136. This determination is explained in further detail below with reference to FIG. 5. The number of contour lines 228 to be used in the elevation map 138 may be a default value or it may be set by a user. For example, as is depicted in FIG. 2B, the value may be ten. The maximum elevation level 230 of the elevation map 138 may be considered the highest point within an elevation map 138. The value of the maximum elevation level 230 may correspond to the highest value of the metric 226 of all of the content elements within the page table 134. For example, if the metric 226 is the number of times a content element has been selected 214 and the range of values for all the content elements for the number of times a content element has been selected 214 is 0-150, then the maximum elevation level 230 would be 150. The contour interval 232 may be the number of contour intervals between the maximum elevation level 230 and the minimum elevation level. The contour interval 232 may be determined by dividing the maximum elevation level 230 by the number of contour lines 228. For example, if the maximum elevation level is 150 and the number of contour lines 228 is ten, then the contour interval 232 would be fifteen. The current level 234 and the current elevation level 236 may be used to determine the elevation level 222 during the process depicted in FIG. 5.

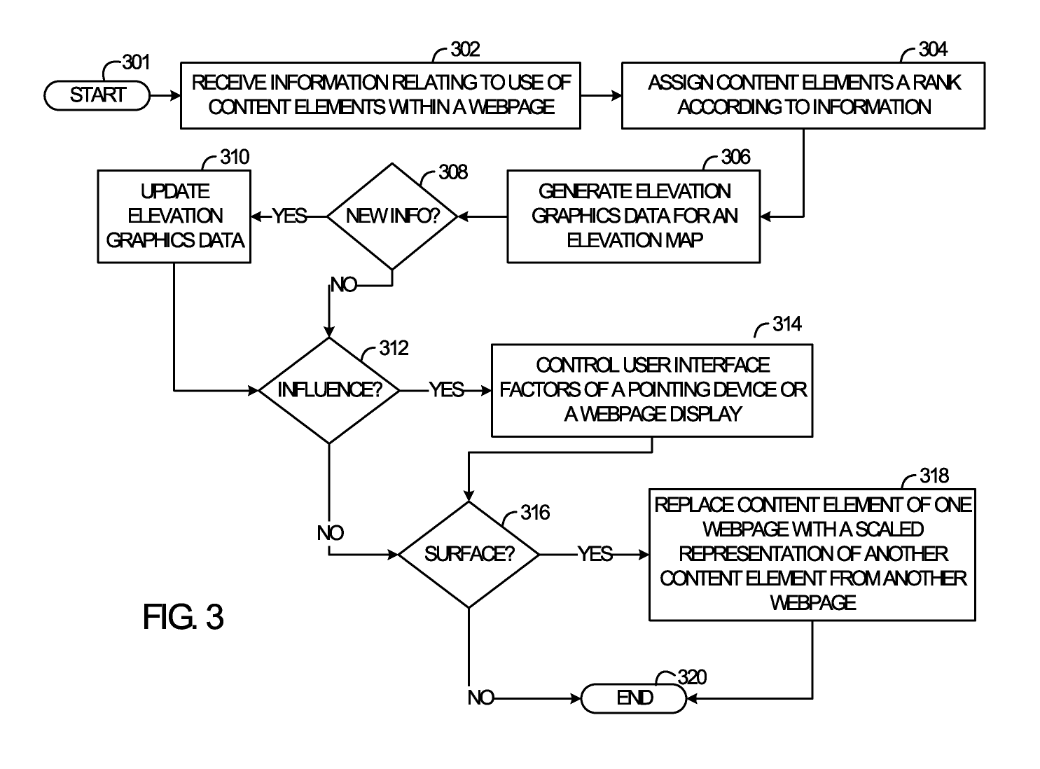

FIG. 3 depicts a block diagram of an example process for receiving information, ranking webpage content elements, generating elevation graphics data for an elevation map, controlling user interface factors of a display, and moving content elements, according to an embodiment of the invention. The process may begin at block 301. Block 302 may contain the operation of receiving information from one or more users relating to use of content elements within a webpage. This information may include any information pertaining to the values stored in the page table 134. This information may be received by a server computer 100 or from a client computer 102 over a network 104. The process of receiving this information and using it to update the page table 134 is explained in further detail below with reference to FIG. 4. Block 304 may contain the operation of assigning the content elements a rank according to the received use information. A rank may be the elevation level 222 for each content element. This process may use any of the metrics of the page table 134 to assign the rank. The process of assigning the content a rank is explained in further detail below with reference to FIG. 5.

Block 306 may contain the operation of generating elevation graphics data for an elevation map 136 of the content elements to be used in conjunction with the webpage, wherein map elevation corresponds to the ranking of the content elements. The elevation program 132 may use the elevation levels 222 provided in block 304 to generate elevation graphics data for an elevation map 138. The elevation map program may use the elevation graphics data to provide the elevation map 138 to the internet browser 130 to be used in conjunction with the webpage. At block 308, a deciding operation may determine if new information has been received. If new information has been received, than the process may move to block 310. The additional information may be received at predetermined intervals and, at block 310, may be merged with the previously received use information to create an updated ranking of the content elements and updated elevation graphics data. This updated information may be received by a server computer 100 or from a client computer 102 over a network 104. The predetermined intervals may be intervals of time or intervals of use of the webpage. For example, the use information may be updated every five seconds, or the use information may be updated whenever a user interacts with the webpage. For example, the use information may update when a user selects a content element within the webpage. This may have the effect of receiving information in real time. Upon completion of the operation of block 310, the process may move to block 312.

Returning to block 308, if new information has not been received, than the process may move to block 312. At block 312, a deciding operation may determine if the elevation program 132 may control user interface factors of a pointing device or webpage display. This determination may include the presence of an elevation map 138. For example, if an elevation map 138 has been generated than the elevation program 132 may control user interface factors of a pointing device or webpage display, but if an elevation map 138 is not present, than there may be no control. If the elevation program 132 may control user interface factors of a pointing device or webpage display, than the process may move to block 314. Block 314 may contain the operation of controlling user interface factors of a pointing device or a webpage display according to the ranking of the content elements of the elevation map. This control may take the form of a pseudo gravity which influences a pointing device or a webpage which may be in a stationary position. The control may also take the form of a pseudo friction which influences a pointing device or a webpage which may be in motion. The process of controlling user interface factors of a pointing device or a webpage display is explained in further detail below with reference to FIGS. 6A and 6B. Upon completion of the operation of block 314, the process may move to block 316.

Returning to block 312, if the elevation program 132 may not control user interface factors of a pointing device or webpage display, than the process may move to block 316. At block 316, a deciding operation may determine if a particular content element is to be replaced by a scaled representation of another content element from another webpage. This determination may include the lapse of a preset duration that begins when a user's pointing device or webpage display becomes static. For example, if a user stops interacting with the webpage a counter starts, and if the counter lapses with no further user interaction content is moved from one webpage to another. If a content element is to be replaced with a scaled representation of another content element from another webpage, than the process moves to block 318. Block 318 may contain the operation of replacing the content element from a one webpage with a scaled representation of another content element from another webpage according to the ranking of the content element. The process of replacing a particular content element is explained in further detail below with reference to FIGS. 7A, 7B, and 7C. Upon completion of the operation of block 318, the process may move to block 320. Returning to block 316, if a content element is not to be moved from one webpage to another, than the process may move to block 320. The process may end at block 320.

FIG. 4 depicts a flowchart of an example process for receiving information relating to use of webpage content, according to an embodiment of the invention. The process may be contained within block 302 as depicted in FIG. 3. The process may begin at block 401. At block 402, a user may open a webpage with an internet browser. At block 404, a page table corresponding to the opened webpage may be loaded. The page table 134 may also be updated by removing content elements from the page table 134 that correspond to content that is no longer present on the webpage, and by adding content elements to the table that correspond to content that has been added to the page table 134 since the webpage was last opened. If a content element is added, the corresponding metrics may be set to a value of zero. At block 406, the value of the number of times a content element is in a display area 216 of a viewed page is incremented by a value of one for all content elements that are currently within the display area of a viewed page. At block 408, a deciding operation determines if user has taken an action. The determination of a user action may be determined with respect to a predetermined period of time. For example, the period of time may be ten seconds. If the period of time lapses without a user action, then it may be determined that there is no user action and the process may move to block 410. At block 410, the process may end.

Returning to block 408, if a user action occurs before the lapse of the predetermined period of time, the process may move to block 411 where a deciding operation determines if the user action identified a focal point of an image element. If the user action is one where a user identifies a content element without selecting it, the process may move to block 412 and the number of times a content element has been identified 218 may be incremented by a value of one for that content element, and the process may proceed to block 416. Returning to block 411, if the user action is not one where a user identifies a content element without selecting it, the process may move to block 413 where a deciding operation determines if the user action was a selection action. If the user action is one where a user selects a content element, for example by clicking or tapping on it, then the process may move to block 414 and the number of times a content element has been selected 214 may be incremented by a value of one for that content element, and the process may proceed to block 416. Returning to block 413, if the user action is not one where a user selects a content element, the process may move to block 416. The process 302 may also be modified to account for any number user actions other than an identification or a selection. For example, if the user zooms in or out, scrolls horizontally or vertically, refreshes the webpage, or performs any other similar action the process 302 may be modified to include one or more operations that catalog those actions as illustrated in the shown embodiment.

At block 416, a deciding operation determines if the display area has changed. This determination may include comparing the content elements within the display area before and after a user action. If the content elements are the same, then the display area has not changed and the process returns to block 408. If the content elements are different after the user action than they were before the user action, then the display area has changed and the process returns to block 406 where the value of the number of times a content element is in a display area 216 is incremented by a value of one for all content elements that are currently within the display area.

FIG. 5 depicts a flowchart of an example process for assigning webpage content a rank, according to an embodiment of the invention. The process may be contained within block 304 as depicted in FIG. 3. The process may begin at block 501. At block 502, the elevation level 222 of all the content elements of the page table 134 may be reset. For example, for all content elements which have a value of zero for the selected metric 226, the value of the elevation level 222 would be set to a value of zero. For example, if the metric 226 selected is the number of times a content element has been selected 214 and the value for this metric is zero for that content element, then the elevation level 222 for that content element would be set to zero. For all other content elements, the value of the elevation level 222 would be set to a value of minus one. At block 504, one or more elevation table 136 values may be set to a scaled value. For example, the maximum elevation level 230, the contour interval 232, the current level 234, and the current elevation level 236 may be set to scaled values. The maximum elevation level 230 may be set to equal the highest value of the metric 226 of all the content elements within the page table 134 as previously explained. The contour interval 232 may be set by dividing the maximum elevation level 230 by the number of contour lines 228 as previously explained. The current level 234 may be set to zero and the current elevation level 236 may be set to equal the current level 234. Also, the current level 234 may be assigned the sum of the current level 234 and the contour interval 232. At block 506, the elevation level 222 of all the content elements of the page table 134 may be assigned new elevation levels 222 in accordance with the scaled valued of the elevation table 136. For example, the elevation level 222 of each content element may be assigned a value within the range of elevation levels that corresponds to the position of the respective content element's metric 226 value within the range of metric values of all content elements. For example, if a content element has a metric 226 value of 50, and the range of metric values of all the content elements is 0-100, and the range of the elevation levels is 0-10, then the elevation level of the content element may be assigned a value of 5. This assignment may be completed for each content element within the page table 134. At block 507, the process may end.

FIG. 6A depicts a flowchart of an example process for using an elevation map 138 to control user interface factors of a pointing device or a display area, according to an embodiment of the invention. The control of this process may be considered a form of a pseudo gravity which influences a pointing device or a webpage which may be in a stationary position as previously explained. A pointing device may be a mouse, trackball, stylus, touchpad or any other similar device. A display area may include the touchscreen of a mobile device such as a smartphone or an electronic tablet. The process may be contained within block 314 as depicted in FIG. 3. In one embodiment the process 314 may not begin until a period of time has passed where a user has not interacted with a pointing device or display. For example, there may be a five second delay between a user's last action and the start of the process. Once the wait time has passed the process may begin at block 301. At block 602, a content element nearest the pointing device or the center of the display area is determined. This determination may include comparing the x,y coordinate location of the pointing device or the x, y coordinate of the center of the display area with the x,y coordinate location 212 of every content element within the page table 134.

At block 604, a content element, other than the determined nearest content element of block 602, which is nearest the pointing device or the center of the display area is determined. This determination may also include comparing the x,y coordinate location of the pointing device or the x, y coordinate of the center of the display area with the x,y coordinate location 212 of every content element within the page table 134. At block 606, the elevation level 222 of the nearest content element and the elevation level 222 of the next nearest content element are compared to determine which of the two content elements has the higher elevation level. At block 608, the user's pointing device or display is moved to the content element with the higher elevation level. This may include moving the pointing device to the x,y coordinate location 212 of the content element with the higher elevation level, or it may include moving the center of the display area to the x,y coordinate location 212 of the content element with the higher elevation level. At block 610, a deciding operation may determine if the pointing device or display has moved to the content element that has the highest elevation level 222 of all the content elements of the webpage. If the pointing device or display has not moved to the content element with the highest elevation level 222, then the process may return to block 602. If the pointing device or display has moved to the content element with the highest elevation level, then the process may move to block 611 where the process may end.

FIG. 6B depicts a flowchart of an example process for using an elevation map 138 to control user interface factors of a pointing device or a display area, according to an embodiment of the invention. The control of this process may be considered a form of a pseudo friction which influences a pointing device or a webpage which may be in motion as previously explained. The process may be contained within block 314 as depicted in FIG. 3. The process may begin at block 613. At block 614, a user moves a pointing device or a display area. For example, a user may move a pointing device with a mouse in relation to the webpage that is being displayed, or a user may move a webpage display by swiping a finger across a touch screen of a device. At block 616, the elevation level 222 of the content element nearest the course to which the pointing device or center of the display area is moving is compared to the elevation level 222 of the content element that was nearest the pointing device or center of the display area when the motion was initiated. At block 618, a deciding operation determines if the user is moving the pointing device or display area toward a content element with the same elevation level 222. This may include comparing the elevation level 222 of the content element that was nearest the pointing device or center of the display area when the motion was initiated to the elevation level 222 of the content element nearest the course to which the pointing device or center of the display area is moving. If the elevation level 222 of the content elements is the same, then the process may move to block 620 where no control of the user interface factors is performed. The process may then move to block 627 where the process may end. Returning to block 618, if the elevation level 222 of the content elements is not the same, then the process may move to block 622.

At block 622, a deciding operation determines if the elevation level 222 of the content element nearest the course to which the pointing device or center of the display area is moving is higher or lower than the elevation level 222 of the content element that was nearest the pointing device or center of the display area when the motion was initiated. If it is higher then the process moves to block 624 where the user interface factors of the pointing device or the display are controlled in such a way as to result in an increase of the movement speed. Once the movement of the pointing device or display has finished the process may move to block 627 where the process may end. Returning to block 622, if it is lower then the process moves to block 626 where the user interface factors of the pointing device or the display are controlled in such a way as to result in a decrease of the movement speed. Once the movement of the pointing device or display has finished the process may move to block 627 where the process may end.

FIG. 7A depicts a flowchart of an example processing for replacing content elements with scaled representation of other content elements, according to an embodiment of the invention. The process may be contained within block 318 as depicted in FIG. 3. As in FIG. 6, the process 318 may not begin until a period of time has passed where a user has not interacted with a pointing device or display. Once the wait time has passed the process may begin at block 701. At block 702, a content element may be selected from the webpage which a user may be currently viewing. This selection may include selecting the content element with the most significant elevation level 222. For example, the content element with the highest elevation level 222 may be the content element with the most significant elevation level 222. In another embodiment, this selection may include selecting the content element which is closest to the pointing device. At block 704, the webpage which is linked to the content element may be checked for the presence of a page table 134. At block 618, a deciding operation determines the linked webpage has a page table 134. If the linked webpage does not have a page table 134 the process may return to block 702 for selection of a different content element. If the linked webpage does have a page table 134 then the process may move to block 708. At block 708, a content element may be selected from the page table 134 of the linked webpage. This selection may include selecting the content element with the most significant elevation level 222. If more than one content element from the page table of the linked webpage has the most significant elevation level 222, then the selection may also include comparing the other metrics of the content elements within the page table in order to select a single content element. For example, if two content elements have the most significant elevation level then the content element with the greater value for the number of times a content element has been identified 218 may be selected. At block 710, the selected content element from the current webpage may be replaced by a scaled representation of the selected content element from the linked webpage.

FIG. 7B depicts a first webpage and a second webpage prior to moving a content element, according to an embodiment of the invention. A currently viewed webpage 712 may contain content elements 714, 716, 718, and 720. The selected content element from block 704 of process 318 may be content element 720. Content element 720 may link to a webpage 722 which may contain content elements 724, 726, 728, and 730. Of the content elements of webpage 722, the content element 728 may have the most significant elevation level 222.

FIG. 7C depicts a first webpage and a second webpage after moving content, according to an embodiment of the invention. Because the content element 728 may have the most significant elevation level 222, the content element 720 of the current webpage 712 has been replaced with a scaled representation of the content element 728 of the linked webpage 722. The surfaced content element 728 may remain linked to its originally linked webpage or content, or its link may change to link to the webpage 722.

Referring back to FIG. 1, in various embodiments, the computer system 100 may be a multi-user mainframe computer system, a single-user system, or a server computer or similar device that has little or no direct user interface, but receives requests from other computer systems (clients). In other embodiments, the computer system 100 may be implemented as a desktop computer, portable computer, laptop or notebook computer, tablet computer, pocket computer, telephone, smart phone, or any other appropriate type of electronic device.

The computer system 102 may include some or all of the hardware and/or computer program elements of the computer system 100. The various program components implementing various embodiments of the invention may be implemented in a number of manners, including using various computer applications, routines, components, programs, objects, modules, data structures, etc., and are referred to herein as “computer programs,” or simply “programs.”

The computer programs include one or more instructions or statements that are resident at various times in various memory and storage devices in the computer system 100 and that, when read and executed by one or more processors in the computer system 100, or when interpreted by instructions that are executed by one or more processors, cause the computer system 100 to perform the actions necessary to execute steps or elements including the various aspects of embodiments of the invention. Aspects of embodiments of the invention may be embodied as a system, method, or computer program product. Accordingly, aspects of embodiments of the invention may take the form of an entirely hardware embodiment, an entirely program embodiment (including firmware, resident programs, micro-code, etc., which are stored in a storage device), or an embodiment combining program and hardware aspects that may all generally be referred to herein as a “circuit,” “module,” or “system.” Further, embodiments of the invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. For example, a computer-readable storage medium may be, but not limited to, an electronic, magnetic, optical, electromagnetic, infrared, or semiconductor system, apparatus, or device, or any suitable combination of the foregoing. More specific examples (an non-exhaustive list) of the computer-readable storage media may include: an electrical connection having one or more wires, a portable computer diskette, a hard disk, a random access memory (RAM), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may include a propagated data signal with computer-readable program code embodied thereon, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagates, or transports a program for use by, or in connection with, an instruction execution system, apparatus, or device. Program code embodied on a computer-readable medium may be transmitted using any appropriate medium, including but not limited to, wireless, wire line, optical fiber cable, Radio Frequency, or any suitable combination of the foregoing.

Computer program code for carrying out operations for aspects of embodiments of the present invention may be written in any combination of one or more programming languages, including object oriented programming languages and conventional procedural programming languages. The program code may execute entirely on the user's computer, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments of the invention are described below with reference to flowchart illustrations and/or block diagrams of methods, apparatus (systems), and computer program products. Each block of the flowchart illustrations and/or block diagrams, and combinations of blocks in the flowchart illustrations and/or block diagrams may be implemented by computer program instructions embodied in a computer-readable medium. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified by the flowchart and/or block diagram block or blocks. These computer program instructions may also be stored in a computer-readable medium that can direct a computer, other programmable data processing apparatus, or other devices to function in a particular manner, such that the instructions stored in the computer-readable medium produce an article of manufacture, including instructions that implement the function/act specified by the flowchart and/or block diagram block or blocks.

The computer programs defining the functions of various embodiments of the invention may be delivered to a computer system via a variety of tangible computer-readable storage media that may be operatively or communicatively connected (directly or indirectly) to the processor or processors. The computer program instructions may also be loaded onto a computer, other programmable data processing apparatus, or other devices to cause a series of operational steps to be performed on the computer, other programmable apparatus, or other devices to produce a computer-implemented process, such that the instructions, which execute on the computer or other programmable apparatus, provide processes for implementing the functions/acts specified in the flowcharts and/or block diagram block or blocks.

The flowchart and the block diagrams in the figures illustrate the architecture, functionality, and operation of possible implementations of systems, methods, and computer program products, according to various embodiments of the present invention. In this regard, each block in the flowcharts or block diagrams may represent a module, segment, or portion of code, which includes one or more executable instructions for implementing the specified logical function(s). In some embodiments, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flow chart illustrations, can be implemented by special purpose hardware-based systems that perform the specified functions or acts, in combinations of special purpose hardware and computer instructions.

Embodiments of the invention may also be delivered as part of a service engagement with a client corporation, nonprofit organization, government entity, or internal organizational structure. Aspects of these embodiments may include configuring a computer system to perform, and deploying computing services (e.g., computer-readable code, hardware, and web services) that implement, some or all of the methods described herein. Aspects of these embodiments may also include analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems. In addition, various programs described herein may be identified based upon the application for which they are implemented in a specific embodiment of the invention. But, any particular program nomenclature used herein is used merely for convenience, and thus embodiments of the invention are not limited to use solely in any specific application identified and/or implied by such nomenclature. The exemplary environments illustrated in the figures are not intended to limit the present invention. Indeed, other alternative hardware and/or program environments may be used without departing from the scope of embodiments of the invention.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, embodiments of the invention may be practiced without these specific details. In other instances, well-known circuits, structures, and techniques have not been shown in detail in order not to obscure embodiments of the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

What is claimed is:

1. A method comprising:
receiving first information relating to use of content elements within a first webpage;
determining a ranking of the content elements according to the first information;
generating elevation graphics data for an elevation map of the first webpage, wherein the elevation graphics data corresponds to the ranking of the content elements; and
controlling user interface factors of the first webpage with respect to the elevation graphics data of the elevation map.

2. The method of claim 1, further comprising:
receiving second information relating to use of content elements within the first webpage;
updating the ranking of the content elements according to the second information; and
updating the elevation map with the updated ranking of the content elements.

3. The method of claim 2, further comprising replacing a first content element of the first webpage with a scaled representation of a second content element of a second webpage.

4. The method of claim 2, wherein the first and second information includes a number of times a content element has been selected.

5. The method of claim 2, wherein the first and second information includes a number of times a content element is presented in a display area of the first webpage.

6. The method of claim 2, wherein the first and second information includes a number of times a content element has been identified.

7. The method of claim 2, wherein the first and second information includes a number of times a scaled representation of a content element has replaced another content element.

8. A method comprising:
receiving first information relating to use of content elements within a first webpage;
determining a ranking of the content elements according to the first information;
generating elevation graphics data for an elevation map of the first webpage, wherein the elevation graphics data corresponds to the ranking of the content elements; and
replacing a first content element of the first webpage with a scaled representation of a second content element of a second webpage.

9. The method of claim 8, further comprising:
receiving second information relating to use of content elements within the first webpage;
updating the ranking of the content elements according to the second information; and
updating the elevation map with the updated ranking of the content elements.

10. The method of claim 8, further comprising controlling user interface factors of the first webpage with respect to the elevation graphics data of the elevation map.

11. The method of claim 9, wherein the first and second information includes a number of times a content element has been selected.

12. The method of claim 9, wherein the first and second information includes a number of times a content element is presented in a display area of the first webpage.

13. The method of claim 9, wherein the first and second information includes a number of times a content element has been identified.

14. The method of claim 9, wherein the first and second information includes a number of times a scaled representation of a content element has replaced another content element.

15. A non-transitory computer readable storage medium having instructions stored thereon which, when executed, cause a processor to perform the following operations:
receiving information relating to use of content elements within a first webpage;
determining a ranking of the content elements according to the information;
generating elevation graphics data for an elevation map of the first webpage, wherein the elevation graphics data corresponds to the ranking of the content elements; and
replacing a first content element of the first webpage with a scaled representation of a second content element of a second webpage.

16. The storage medium of claim 15, further comprising the operation of controlling user interface factors of the first webpage with respect to the elevation graphics data of the elevation map.

17. The storage medium of claim 15, wherein the information includes a number of times a content element has been selected.

18. The storage medium of claim 15, wherein the information includes a number of times a content element is presented in a display area of the first webpage.

19. The storage medium of claim 15, wherein the information includes a number of times a content element has been identified.

20. The storage medium of claim 15, wherein the information includes a number of times a scaled representation of a content element has replaced another content element.
